(19) United States
(12) Patent Application Publication
(10) Pub. No.: US 2024/0298583 A1
(43) Pub. Date: Sep. 12, 2024

(54) PLANT CULTIVATION DEVICE

(71) Applicant: 4S AACHEN GMBH, Aachen (DE)

(72) Inventor: Florian Köhler, Aachen (DE)

(21) Appl. No.: 18/272,149

(22) PCT Filed: Jan. 13, 2022
(86) PCT No.: PCT/EP2022/050654

§ 371 Date: Jul. 13, 2023

(30) Foreign Application Priority Data
Jan. 13, 2021 (DE) 10 2021 200 267.6

(51) Int. Cl. A01G 9/24; A01G 9/26; A01G 13/08; A01G 27/00

(52) U.S. Cl. CPC A01G 9/249; A01G 9/241; A01G 9/247; A01G 9/26; A01G 13/08; A01G 27/003

(57) ABSTRACT

The invention relates to a plant cultivation device (1) having a watering apparatus (2), an illumination device (3), a receiving space (4) for receiving one or more carrier substrates (5) and seeds, a control unit (6) which is configured to control the watering apparatus (2) and the illumination device (3) by means of a program controller, one or more moisture sensors (7a, 7b) for measuring the air humidity (7a) and/or substrate moisture (7b), a sensor (8) for determining the photosynthesis rate and an optical evaluation unit (11) for determining the plant type and its stage of growth, the illumination parameters of the illumination device (3) being variable and the illumination parameters of the illumination device being adjusted following a correlation determined between the illumination parameters and the photosynthesis rate measured and/or the plant growth measured.

### SUMMARY OF THE INVENTION

The present invention relates to a plant cultivation device for optimizing the growth of plants, depending on their growth stages and photosynthesis rates. Such a device comprises an irrigation device, a lighting device, a receiving space for receiving carrier substrate and seeds, a control unit adapted to determine the optimum conditions by means of software and to control the irrigation device and the lighting device, and one or more sensors for determining the humidity of the air and/or the substrate.

The task of embodiments of the invention is to provide a system that can take over the raising of plants fully and/or semi-automatically and can support the plants in their growth by providing them with the optimal parameters for them. This system is also to be optimized in its energy consumption.

This task is solved by the object of the independent claim. Advantageous further developments are the subject of the dependent claims.

The measure that several light sources above and/or to the side and/or below the plant are controlled by the control unit in such a way that the direction of growth of the plant along radii of curvature is selected in such a way that the area utilization of the carrier substrates is increased, contains numerous advantages and can be realized in a variety of ways.

In this way, the principle that growth processes of plants take place in the direction of the incidence of light can be used for a targeted shaping of the plant(s), in particular in that the lighting device is designed in such a way that light can be irradiated along different light cones and that light is irradiated with a higher intensity in the area of a first light cone, in the area of which the plant growth is to be increased more strongly than in the area of a second light cone.

A particularly advantageous embodiment of the invention provides that several light sources are arranged at different locations and that an intensity of light sources in the areas where stronger plant growth is to take place is regulated to be greater than an intensity of light sources in the areas where weaker plant growth is to take place.

It is particularly advantageous to provide the plant cultivation device with a detection unit for a spatial expansion of plants. This enables a particularly advantageous adjustment of the lighting parameters.

The adjustment of the lighting parameters is expediently used for the best possible utilization of a volume of the plant cultivation device and/or to prevent shading of lower lying parts of the plants by higher lying components of the plants.

In an advantageous further development of the plant cultivation device, the detection unit for the spatial expansion of plants can comprise an optical evaluation unit one or more cameras that can also record the IR spectrum in addition to the visible spectrum. This offers the advantage that, in addition to the possibility of recognizing the plant species and its growth stage, the vitality of the plant can also be recognized on the basis of its reflectance.

An appropriate embodiment of the invention is characterized by the fact that the lighting device is designed in such a way that light can be irradiated along different light cones and that light is irradiated with a higher intensity in the area of a first light cone, in the area of which plant growth is to be increased more strongly, than in the area of a second light cone.

An advantageous further development of the invention provides that the plant cultivation device is provided with a detection unit for a spatial extension of plants, that the detection unit is designed in such a way that the detection unit can transmit the detected spatial extension of the plants to an evaluation unit, that the evaluation unit is set up in such a way that it can carry out a comparison between the detected spatial extension of the plants and desired values for the spatial extension of the plants, and that the evaluation unit is set up in such a way that it can carry out a comparison between the detected spatial extension of the plants and desired values for the spatial extension of the plants, in that it can carry out a comparison between the detected spatial extent of the plants and setpoint values for the spatial extent of the plants, and in that the evaluation unit can generate data for adapting the lighting parameters as a function of the comparison between the detected spatial extent of the plants and the setpoint values for the spatial extent of the plants and can transmit said data to the control unit.

An appropriate embodiment of the invention is characterized in that illumination parameters of the illumination device are adjusted and that several light sources above and/or laterally and/or below the plant are controlled by the control unit in such a way that the direction of growth of the plant along radii of curvature is selected in such a way that the area utilization of the carrier substrates is increased.

An advantageous further development of the invention provides that the lighting parameters of the lighting device are adapted in such a way that light is irradiated along different light cones and that light is irradiated with a higher intensity in the area of a first light cone, in the area of which plant growth is to be increased more strongly, than in the area of a second light cone.

An appropriate embodiment of the invention is characterized in that a detection unit detects a spatial extent of plants, in that the detection unit transmits the detected spatial extent of the plants to an evaluation unit, in that the evaluation unit carries out a comparison between the detected spatial extent of the plants and setpoint values for the spatial extent of the plants, and in that the evaluation unit generates data for adapting the lighting parameters as a function of the comparison between the detected spatial extent of the plants and the setpoint values for the spatial extent of the plants and transmits this data to the control unit.

An advantageous further development of the invention provides that an optical evaluation unit of the plant cultivation device is used to determine the plant species and its growth stage, its vitality and to diagnose mold infestation, and that the lighting parameters of the lighting device are adjusted to promote plant growth following a determined correlation between the lighting parameters and the measured photosynthesis rate and/or the measured plant growth.

According to one embodiment of the invention, this task is solved by a plant cultivation device comprising an irrigation device, a lighting device, a receiving space for receiving one or more carrier substrates and seeds, a control unit which is set up to control the irrigation device and the lighting device by means of a program control, one or more humidity sensors for measuring the air and/or substrate humidity and an optical evaluation unit for determining the plant species and its growth stage, the lighting device of which is variable in its lighting parameters and adjusts the lighting parameters of the lighting device following a determined correlation between the lighting parameters and the measured photosynthesis rate and/or the measured plant growth. This has the advantages that the plants are monitored throughout their development and that they receive the optimal supply for their species and current growth phase, depending on the determined correlation.

The lighting unit can have several light sources above and/or to the side and/or below the plant. This has the advantage that all areas of the plant can be illuminated individually and the plant can grow on radii of curvature in the area. The parameters that can be changed by the control unit can include the distance of the light sources to the plants and/or the beam angle and/or the intensity and/or the spectral composition of the emitted light of the light source or light sources. This has the advantage that a high degree of precision is possible in the adaptation by means of the control device to the needs of the plant. Furthermore, places on the plant that are covered by its leaves, for example, can be illuminated with the aid of the present further development and the use of the area can be increased through growth in width.

In advantageous further development, the optical evaluation unit can comprise one or more cameras that can also record the IR spectrum in addition to the visible spectrum. This offers the advantage that, in addition to the possibility of recognizing the plant species and its growth stage, the vitality of the plant can also be recognized on the basis of its reflectance. Furthermore, the evaluation unit can use software to determine where the active light sources are located and to recognize their distance from the plants as well as their angle of radiation. The recognition of the plant type and its growth stage can take place via a comparison with a database, as is already used in some apps. Furthermore, the evaluation unit can be programmed to detect whether a plant is infested with mold and/or to infer the photosynthesis rate of the plant. The photosynthesis rate is determined by exploiting chlorophyll fluorescence. In this process, the plants absorb the energy of the light in the chlorophyll and glow faintly in the red range during photosynthesis. This glow can be used as an indicator to draw conclusions about the photosynthetic activity of the plant.

The LEDs of the lighting device can additionally emit light in the UV and IR spectrum and be switched on by the control unit as required. It has been shown that certain spectral components of the UV light can have positive effects on plant growth, especially towards the end of their flowering period. In addition, mold can be controlled with the help of the UV LEDs. IR radiation can be used to determine vitality.

In a further embodiment, the plant cultivation device may comprise a ventilation device. This can be used to control mold and to pollinate the plants during the flowering period.

In support of this, the control unit monitors the humidity with the aid of the substrate and/or air humidity sensors and controls the UV LEDs and/or ventilation device from a humidity threshold value in such a way that mold formation is prevented.

The watering device of the plant cultivation device can be formed by open channels. The open channels improve the air exchange and contribute to root respiration by improving the aeration of the roots. This results in a higher nutrient uptake by the plant. In this further development, the use of sensors for measuring a conductance value with regard to the quality of the water supplied and removed is provided. This allows conclusions to be drawn about the transport properties of the water and its composition. However, other sensors are also conceivable, for example for measuring the pH value of the water. In this way, the user can obtain information about the nutrient concentration of the solution and adjust it if necessary.

In one embodiment of the invention, the photosynthesis rate can be determined with the aid of a gas sensor that is able to determine the CO2 and/or O2 content of the air and deduce from this how much photosynthesis the plant is performing. Knowing the CO2 level of the air surrounding the plant is of high importance, as the photosynthesis rate depends on the CO2 available for photosynthesis and thus the optimal light parameters, especially the light intensity, of a plant have to be adjusted. This underlines the importance of the software used to determine the correlation, as it is able to optimally adjust the conditions for each plant based on the measured data. The values stored in the database serve as a starting point for the control unit, from which the lighting parameters are then successively adjusted based on the determined correlation.

The plant cultivation device can be sealed off from the outside air. This results in increased precision of the sensor for determining the photosynthesis rate.

In one embodiment of the invention, the control unit for detecting the correlation can be a PID controller. This offers the advantage that, in addition to linear correlations between plant development and the light parameters, integral or differential correlations are also detected. In particular, the controller is programmed in such a way that when growth saturation is reached, the intensity of the light sources is not increased further. In addition to the aforementioned prevention of damage to the plants, this also has the advantage that electricity costs are saved.

Overall, the control device in combination with the optical evaluation unit can be trained in the manner of machine learning to allow the plants to grow along radii of curvature in the area and thus achieve an increase in the area utilization of the carrier substrates.

In a further embodiment, the plant raising device is modularly expandable vertically by stacking multiple plant raising devices in the manner of beams of a shelf. This can increase the commercial benefit of the design by potentially multiplying the yield per area.

In a particularly advantageous further development, the program control of the control device may be implemented by a learning or self-learning system. Such a system may, for example, be formed by a neural network and evolve via semi-supervised learning, reinforcement learning, active learning or self-learning. This offers the advantage that the controller becomes increasingly precise in its determination of correlations and that the weighting of the measured values of the optical evaluation unit and the sensors is continuously adjusted for each plant.

### BRIEF DESCRIPTION OF THE DRAWINGS

An embodiment of the invention with various further embodiments and embodiments is shown in the drawings and is described in more detail below. It shows

FIG. 1a plant cultivation device in cross-section with sensors and devices in schematic view, and

FIG. 2 two plant cultivation devices arranged one above the other in the manner of a shelf.

### DETAILED DESCRIPTION OF THE INVENTION

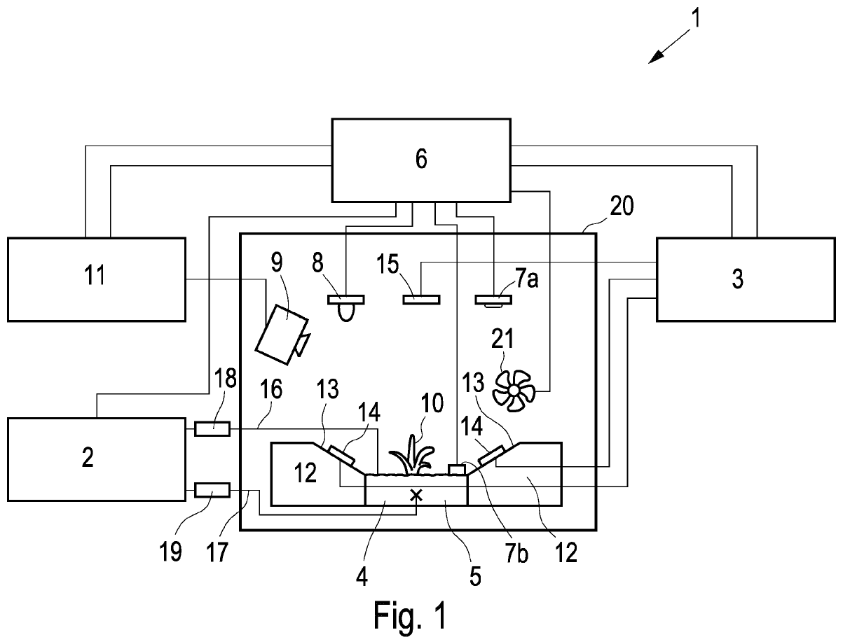

FIG. 1 shows a plant cultivation device 1. The plant cultivation device 1 has a watering device 2, a lighting device 3, a receiving space 4 for receiving one or more carrier substrates 5 and seeds, a control unit 6 which controls the watering device 2 and the lighting device 3 via a program control, humidity sensors 7a, 7b for measuring the air humidity (7a) and substrate humidity (7b), a CO2 gas sensor 8 and a camera 9. The camera 9 may be capable of recording the IR spectrum in addition to the visible spectrum and is connected to an optical evaluation unit 11. The recording space 4 is bounded by a frame 12 which has sloping sides 13 facing the recording space 4, on the surface of which lines can run and LEDs 14 connected to the illumination device 3 can be located. The angle of inclination of the surface 13 facing the receiving space 4 can be designed to be variable so that the angle of illumination of the LEDs 14 can be varied. A further LED 15 is located above the carrier substrate 5 and its height can be varied. The angle of inclination and the height are parameters that can be changed by the lighting device 3. Further functions of the illumination device 3 include changing the beam angle of the LEDs 14, 15 and changing the intensity and spectral composition of the emitted light of the LEDs 14, 15. By way of example, the red and blue components, the UV-A, UV-B and UV-C components of the UV spectrum and the IR components of the LEDs 14, 15 can be changed by the illumination device 3.

The water pipes 16, 17 of the irrigation device 2 required for irrigation are only shown schematically in FIG. 1 and can be formed via open channels. Sensors 18, 19 for measuring a conductance and/or a pH value determine the quality and composition of the water supplied and discharged.

The receiving space 4 with frame 12 and carrier substrate 5, the CO2 gas sensor 8, the light sources 14, 15, the camera 9 and the humidity sensors 7a, 7b may be separated from the ambient air by a wall 20 made of glass or other materials. In addition, a ventilation device 21 controllable by the control device 6 may be installed.

In a particularly advantageous embodiment of the plant cultivation device 1, the optical evaluation unit 11 is able, with the aid of its camera 9, to analyze the plants 10 with regard to their type, their growth stage and their vitality state and to make a diagnosis in the event of mold infestation. This data is transmitted to the control unit 6. The type and growth stage of the plant 10, as well as the CO2 content of the air measured by the gas sensor 8, form an initial value for the parameters to which the control unit 6 delivers the lighting device 3. In the case of a mold diagnosis, the control unit 6 can switch on the UV spectrum of the LEDs 14, 15 of the lighting unit 3 and/or switch on the ventilation device 21. Based on the start value, a correlation between the lighting parameters, the CO2 content of the air, the air and substrate humidity, the water quality and the growth of the plant 10 is now determined via software. When the optical evaluation unit 11 detects that the leaves of the plant 10 cast a shadow on the underlying parts of the plant 10, the side-mounted LEDs 14 can be used to make the plant 10 grow along radii of curvature and increase the use of the area of the supporting substrate 5. It is particularly advantageous if the program control of the control device 6 is designed to be learning or self-learning and takes over the control of the plant growing device 1 fully automatically.

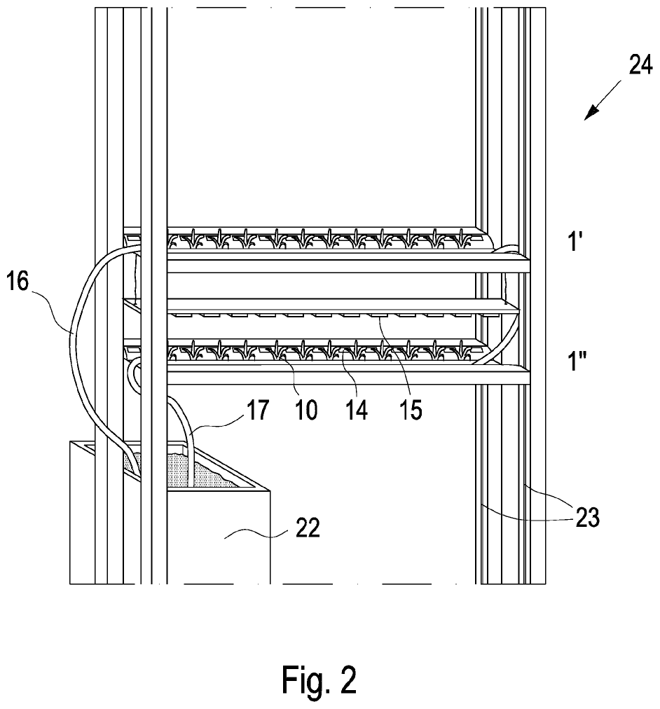

The yield per area can be further increased by designing the plant cultivation device 1 to be vertically expandable in a modular way, as shown in FIG. 2. The upper plant cultivation unit 1′ does not have to be the top rail, but other levels above it are also conceivable. For the sake of simplicity, not all components of the plant cultivation devices 1′, 1″ are shown here. The rails that support the plant cultivation devices 1′, 1″ are inclined towards each other at a slight angle in order to promote the passage of water. The rails are continuously adjustable in the runners 23 of the shelf 24. The adjustment can be made with the aid of small electric motors controlled by the control unit 6 and not further shown here. In an advantageous manner, the LEDs 15 are directly attached to the underside of the upper plant cultivation device 1′ in order to save space.

### LIST OF REFERENCE SIGNS

1: Plant cultivation device
2: Irrigation device
3: Lighting equipment
4: Recording room
5: Carrier substrate
6: Control unit
7: Humidity sensors
8: Gas sensor
9: Camera
10: Plant
11: Optical evaluation unit
12: Frame
13: Bevelled surface
14: LED
15: LED
16: Feeding water pipe
17: Draining water pipe
18: Water conductivity sensor
19: Water conductivity sensor
20: Wall
21: Ventilation device
22: Water tank
23: Skids
24: Shelf

1. A plant cultivation device, comprising:
an irrigation device;
a lighting device;
a receiving space for receiving one or more carrier substrates and seed;
a control unit arranged to control the watering device and the lighting device by means of a program control;
wherein the lighting device is variable in its lighting parameters, in that the plant growth promotion device has an optical evaluation unit for determining the plant type and its growth stage, its vitality and for diagnosing mold infestation, and in that the plant growth promotion device adjusts the lighting parameters of the lighting device following a determined correlation between the lighting parameters and the measured photosynthesis rate and/or the measured plant growth, and in that a plurality of light sources above and/or to the side of and/or below the plant are controlled by the control unit in such a way that the direction of growth of the plant along radii of curvature is selected in such a way that the area utilization of the carrier substrates is increased.

2. The plant cultivation device according to claim 1,
the lighting device is designed in such a way that light can be irradiated along different light cones and that light is irradiated with a higher intensity in the area of a first light cone, in the area of which plant growth is to be increased more strongly, than in the area of a second light cone.

3. The plant cultivation device according to claim 1,
wherein the plant cultivation device is provided with a detection unit for a spatial extent of plants, in that the detection unit is designed such that the detection unit can transmit the detected spatial extent of the plants to an evaluation unit, in that the evaluation unit is set up such that it can carry out a comparison between the detected spatial extent of the plants and setpoint values for the spatial extent of the plants, and in that the evaluation unit is set up such that it can carry out a comparison between the detected spatial extent of the plants and setpoint values for the spatial extent of the plants, in that it can carry out a comparison between the detected spatial extent of the plants and setpoint values for the spatial extent of the plants, and in that the evaluation unit can generate data for adapting the lighting parameters as a function of the comparison between the detected spatial extent of the plants and the setpoint values for the spatial extent of the plants and can transmit said data to the control unit.

4. The plant cultivation device according to claim 1, wherein the lighting device comprises several light sources above and/or to the side and/or below the plant, in that the light sources can emit visible light as well as light in the UV and IR spectrum, and in that the lighting parameters which can be varied by the control device comprise the distance of the light sources from the plants, the radiation angle, the intensity and the spectral composition of the emitted visible and/or invisible light of the light sources.

5. The plant cultivation device according to claim 1, wherein the plant cultivation device has a sensor for determining the photosynthesis rate in the form of a CO2 and/or an O2 gas sensor.

6. The plant cultivation device according to claim 5, wherein the plant cultivation device is sealed off from the outside air.

7. The plant cultivation device according to claim 1, wherein the optical evaluation unit comprises one or more cameras which, in addition to visible light, can also measure IR radiation.

8. The plant cultivation device according to one claim 1, wherein the optical evaluation unit determines the photosynthesis rate by means of fluorescence measurements.

9. The plant cultivation device according to claim 1, wherein the device comprises a ventilation device, which can be regulated by the control device, for pollinating flowers and/or for freeing the plants from mold infestation.

10. The plant cultivation device according to claim 1, wherein the irrigation device is formed by open channels, and in that sensors, in particular for measuring a conductance value and/or a pH value, are formed for determining the quality of the water supplied and discharged.

11. The plant cultivation device according to claim 1, wherein the control unit detecting the correlation is a PID controller, and that the lighting unit is controlled in such a way that when growth saturation is reached, the intensity of the light sources is not increased further.

12. The plant cultivation device according to claim 1, wherein the device is vertically extendable in the form of a module.

13. The plant cultivation device according to claim 1, wherein the program control of the control device is implemented by a learning or self-learning system.

14. A method for operating a plant cultivation device, with a lighting device, in particular for operating a plant cultivation device according to claim 1,
wherein illumination parameters of the illumination device are adjusted and in that several light sources above and/or to the side and/or below the plant are controlled by the control unit in such a way that the direction of growth of the plant along radii of curvature is selected in such a way that the area utilization of the carrier substrates is increased.

15. The method according to claim 14,
wherein the lighting parameters of the lighting device are adapted in such a way that light is irradiated along different light cones from one another and in that light is irradiated with a higher intensity in the region of a first light cone, in the region of which plant growth is to be increased more strongly, than in the region of a second light cone.

16. The method according to claim 14,
wherein a detection unit detects a spatial extent of plants, that the detection unit transmits the detected spatial extent of the plants to an evaluation unit, that the evaluation unit carries out a comparison between the detected spatial extent of the plants and set values for the spatial extent of the plants and that the evaluation unit generates data for an adaptation of the lighting parameters in dependence on the comparison between the detected spatial extent of the plants and the set values for the spatial extent of the plants and transmits them to the control unit.

17. The method according to claim 14,
wherein an optical evaluation unit of the plant cultivation device is used to determine the plant species and its growth stage, its vitality and to diagnose mold infestation, and in that, in order to promote plant growth, the lighting parameters of the lighting device are adjusted following a determined correlation between the lighting parameters and the measured photosynthesis rate and/or the measured plant growth.
